(19) United States
(12) Patent Application Publication
(10) Pub. No.: US 2009/0266648 A1
(43) Pub. Date: Oct. 29, 2009

(54) Modular Elevator With a Self-Propelled Cabin on a Mast

(76) Inventors: Juan Luis Asensio Bazterra, San Sebastian (ES); Patxi Xabier Uranga Santamaria, San Sebastian (ES)

Correspondence Address: WENDEROTH, LIND & PONACK, L.L.P., 1030 15th Street, N.W.,, Suite 400 East, Washington, DC, 20005-1503, US

(21) Appl. No.: 12/226,269

(22) PCT Filed: Apr. 11, 2007
(86) PCT No.: PCT/ES2007/000211

§ 371 Date: Feb. 25, 2009

(30) Foreign Application Priority Data
Apr. 11, 2006 (ES) P 200600928

(51) Int. Cl. B66B 9/02

(52) U.S. Cl. 187/270

(57) ABSTRACT

We have described a modular lift with a motorised cabin on a mast with a simpler, more comfortable and faster assembly with safer use than conventional mechanisms of the same type. The modular lift is made up of a carrying element or mast into which the rack has been incorporated and is formed by multiple successive modules screwed at the adjoining ends which allow it to be built to the required height, with the modules anchored via bracings. The moving parts are made up of the cabin constructed based on a parallelepiped mast that incorporates the rolling and guiding parts of the lift, the traction groups, the parachute brake, the suspension and the button control panel. Upper and lower guiding rollers are placed on the inclined sides at the rear with respect to the back wall of the cabin and attack pinions in relation to engagement with the rack.

### OBJECT OF THE INVENTION

The object of this invention is a modular elevator with a self-propelled cabin on a mast, which offers new essential characteristics and notable advantages over similar means and devices known in the current technical scene.

More specifically, the invention refers to rack and pinion drive elevator, with a mobile element with a cabin and a modular load-bearing member, made of sections of mast that adapt to any construction, permanent or non-permanent. It is used to carry people and/or loads, as well as to carry out high-rise work.

The scope of application for the invention is obviously the industrial sector that is dedicated to construction and/or the installation of elevating and loading systems, because other people will use it and because it can transport other kinds of loads.

### BACKGROUND OF THE INVENTION

There is a large number of elevators that use the rack and pinion drive system for many buildings, such as bridges, aqueducts or lighthouses; and for large structures, such as cranes, scaffolding, watch and control towers, wind towers, etc.; and to carry out a wide range of jobs such as removals, repair and/or maintenance of facades, general maintenance, etc. It is used for an increasing number of applications and professional sectors because of obvious practical reasons—convenience and, mainly, safety in the workplace.

For all these reasons, all technical manufacturers have the same requirement—to save space in the elevator configuration and guarantee safety of the mobile element while it moves.

The invention has developed a modular elevator which is described in detail below. The parts and components that make up the mobile element have been assembled and the load-bearing member has been fixed in a new, practical and advantageous way. This way the elevator can be as compact as possible and the load-bearing member can be nearer to the enclosure in which the elevator is going to operate, and it can also be installed in small spaces without compromising safety, efficiency and comfort.

### SUMMARY OF THE INVENTION

The modular elevator to transport of people and/or loads that is shown herein includes a modular load-bearing member and a mobile element that make up the actual elevator. The construction in which the elevator is going to operate can be permanent or non-permanent.

The load-bearing member is made of modules that consist of sections of the mast, of structural tube, with the rack fixed at the end of each side, screwed together at each end. These sections of the mast are anchored to the construction with bracing that adapts to the type of application of the elevator.

Because the load-bearing member is modular, the elevator can be built in sections—operators can assemble sections of the mast, one on top of another, and at the same time they can join the fixing devices to the masts in order to anchor the modules to the construction. To disassemble the elevator, the order of this procedure is reversed.

The mobile element is a cabin with a frame with the rolling and guiding elements of the elevator, the drive groups, the parachute brake (if there is one), the suspension organs and the button panel. All these elements are integrated in a parallelepiped, enclosed all around. The main purpose is to protect people, the load and the elements of the drive groups, the parachute brake (if there is one), and control elements, which are housed inside. The cabin has access doors, windows, a trapdoor on the floor and a hatch on the ceiling to get out of the cabin. There are also lower and upper safety trays to detect any possible obstacle that may be in the way of the elevator.

This configuration reduces the surface of the mobile element base notably, while keeping the dimensions inside. It also enables access from the inside of the cabin to all the necessary elements for the elevator to work properly.

In the elevator, the cabin and the frame are one single unit, made up of welded square tubes with the profiles folded in ‘b’, forming a parallelepiped. The profiles folded in ‘b’ are placed in parallel position at the front of the cabin and they guide the guillotine door to enter the elevator. The tubes are joined together with the top and lower crossbeams, which form a vertical rectangular frame. Half-way up there is a square tube that divides this area in two areas of different sizes. The lower one (which will be used as entrance and exit to the cabin) is larger than the top one (which will be used as a window). Parallel to the previous elements, there is another rectangular wall on the cabin, formed by square tubes that are welded together. The four corners of both the wall structures described above are joined together with horizontal square tubes, which close the parallelepiped shape.

The back wall is made of 3 vertical square tubes, welded to a top crossbeam and a lower crossbeam, forming a vertical rectangular frame. Both the top and lower crossbeams are square tubes. The central vertical tube divides the rectangle in two sections of the same size, approx. Looking from the entrance towards the mast, on the section on the left there is a series of horizontal round tubes welded onto both vertical jambs. The tubes are placed at the same distance from each other, forming a vertical ladder inside the cabin. The horizontal tubes and the vertical jambs are joined together with arms, like lugs, that separate the steps from the cabin wall. On the lower part of this section there is an eyebolt welded between two square tubes that join the central vertical tube and the left vertical one. Just above half-way up the left area, there is a horizontal square tube that joins both vertical jambs, to reinforce the structure.

On the opposite side—the area on the right according to the reference given above—there are two square tubes, welded to the vertical jambs, which divide the right area in three parts. The top and lower areas are the same size and larger than the central area. Both areas have a plate joined to the crossbeam, to the vertical jamb and to the dividing tube to which the drive groups and the parachute brake (if there is one) are screwed from the inside, placed in opposite direction from each other. The flange of the reducing gear is put in the circular hole that is made on the plates, through which the axles are placed.

The way it is built eliminates the risk of the pinion and rack disengaging, thanks to the position of the gear motors, which are placed in reverse order, with the release levers near each other, which makes it easier to activate them. They are also near the guide rollers to make sure that the pinion engages with the rack completely, regardless of the irregularities of the load-bearing member. This situation is reinforced by the fact that the pinions are wider than the rack. This also happens when the lower drive group is replaced with a parachute brake.

This layout keeps both elements engaged during the whole path. The direction of the path is affected by the layout and shape of the construction to which the modules have to be attached to form the load-bearing member.

Each drive group and the parachute brake (if there is one) are protected with a metal cover, which prevents occupants in the cabin from getting trapped accidentally and facilitates the access to the drive groups and/or parachute from inside the cabin. These covers have slits where the release levers for the motor brakes are installed, while the central area has a button panel to operate the elevator from inside. This button panel rests on a vertical ‘U’-shaped support, which is joined to a horizontal angular profile (on the lower part), and to a horizontal arm (on the top part), which are joined to the vertical jambs. The rest of the surface of the back wall has a perforated sheet to prevent people from getting trapped.

The left wall of the cabin parallelepiped, looking from the entrance, is divided by two horizontal square tubes in three areas of different sizes. Both these tubes are welded very closely together and they are used to place a welded eyebolt between them on the outside of the cabin. Out of the remaining areas, the lower one is larger than the top one. The top one is used for a window and the lower and central ones are closed by a perforated sheet.

The right wall of the cabin parallelepiped, looking from the entrance, is closed with a perforated sheet, where there is a slit at one end of the rectangle, near the access door and a just above the centre of the rectangle. The release lever for the access door can be found in that slit. On the top of this wall there is a support that is made of three square tubes, which form a rectangle with the top horizontal crossbeam. It supports the electrical cabinet of the elevator, which is screwed onto two strips that are welded onto the support.

The modular load-bearing member (mast) rises vertically above the construction, between the jambs of the self-propelled cabin on a mast in the existing space between the guide rollers and the drive pinions. All four back guide rollers project above four square tubes that are welded perpendicularly to the back wall of the cabin, specifically two on the top crossbeam and two on the lower crossbeam. These tubes are stiffened by square tubes that join the ends of the crossbeams and project above them. On one of the top stiffeners there is a support where the limit switches of the end of the elevator path are assembled. These rollers are placed at about 45° from the back wall of the cabin, with supports welded onto the ends of the previously mentioned tubes. The rollers guide the cabin on the back corners of the mast. On the support of one of the top rollers there is a welded support for the mast inductive sensor. On the front of the mast, the path is guided with three rollers, one on the top part and two on the lower part. On the top part, the roller support is welded to the horizontal crossbeam of the cabin and is placed at about 45° from the back wall of the cabin, to guide the path on the corner of the mast that is opposite to where the rack is welded. On the lower part there is a roller support welded at the same angle as the one described for the top part, to guide the path on the same corner of the mast. The other guide roller is welded to the crossbeam, perpendicular to the back wall. That way the path is guided on the flat side of the mast, in a position that is near the corner where the rack is welded.

The advantages of this modular elevator with a self-propelled cabin on mast can be seen in the description above. It adapts to any kind of permanent or non-permanent construction. It is versatile because all the elements have been made as compact as possible, and because it is efficient and safe while moving. This is achieved because the cabin is well engaged to the load-bearing member (mast), it is easy to assemble and to carry out maintenance, and because it is possible to have access to all the elements of the elevator from the cabin. The use of the structural tube mast also enables the assembly of the elevator, keeping the original service staircase in the construction. The elevator can be assembled in the shaft and it is normally placed between the original staircase and the wall of the construction.

### BRIEF DESCRIPTION OF THE PICTURES

In order to make the detailed explanation of the invention clearer, below there are several pictures that represent the preferred way to carry out the invention. In the pictures:

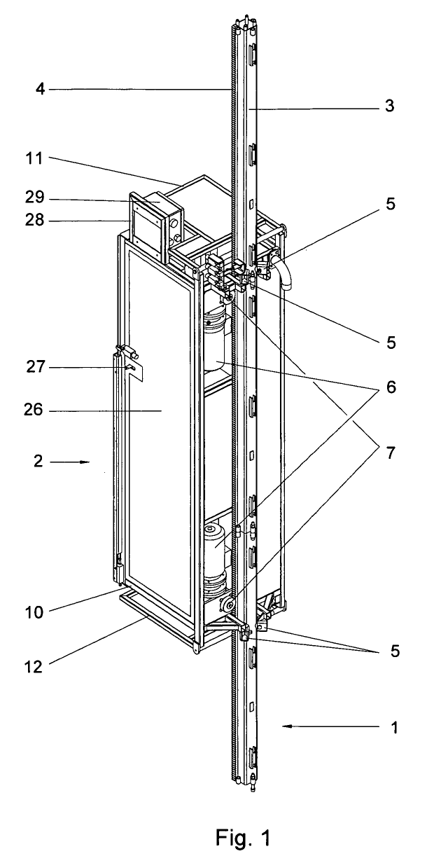

FIG. 1 shows a perspective view of the modular load-bearing member (mast) with the mobile element fixed to it;

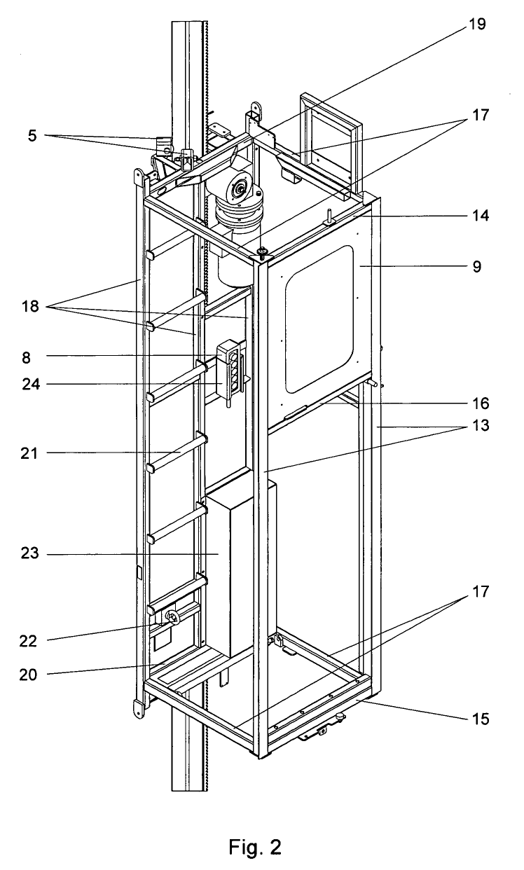

FIG. 2 shows a perspective view of the self-propelled cabin on a mast;

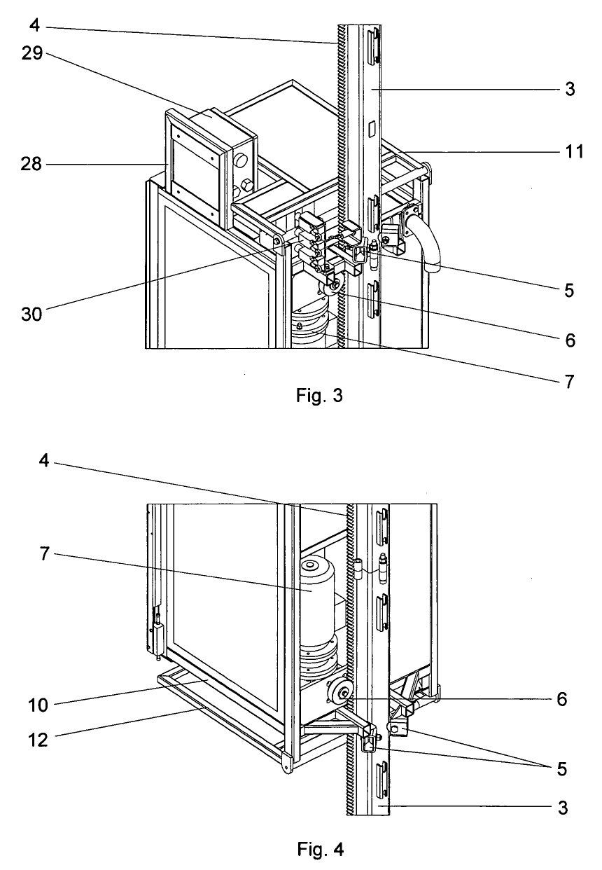

FIGS. 3 and 4 show details of the layout of the fixing elements and vertical guide, respectively;

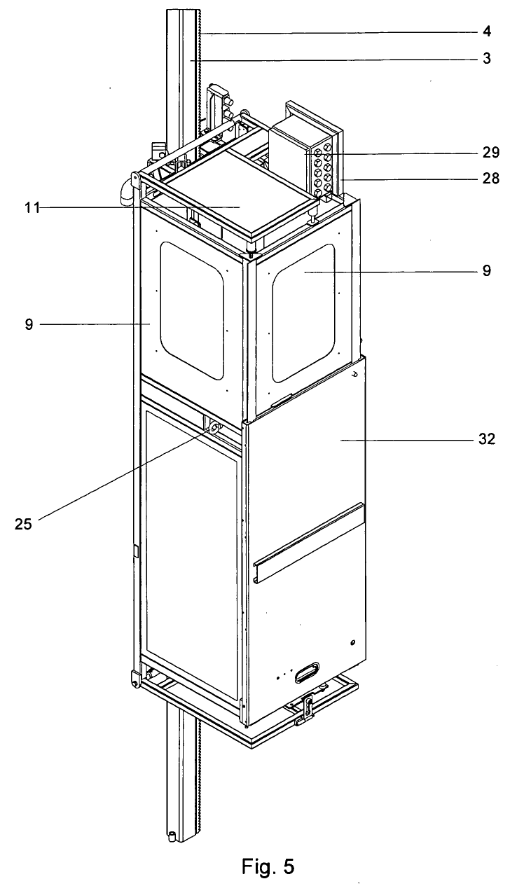

FIG. 5 shows a perspective view of the elevator, from the side that is opposite to the mast; and

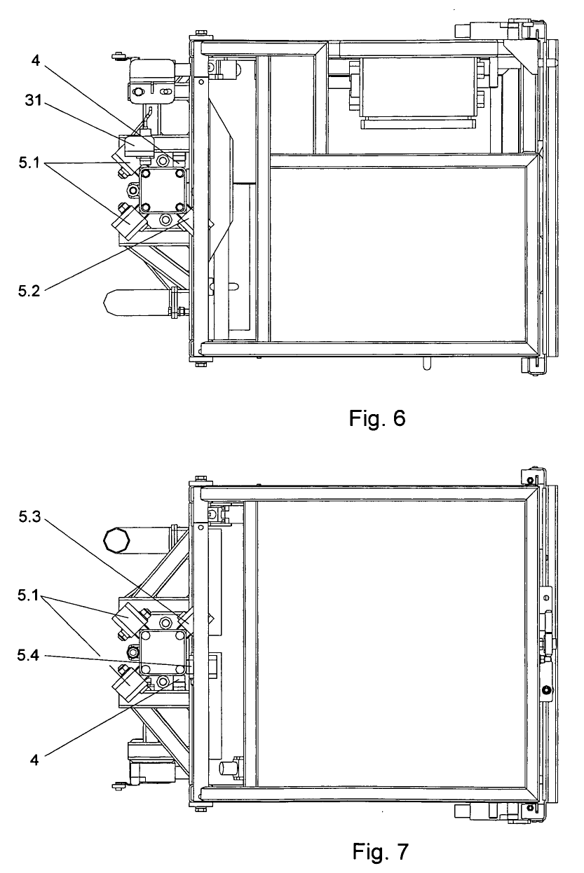

FIGS. 6 and 7 are plan views that show the fixing devices and guide of the elevator to the mast, on the top and lower parts respectively.

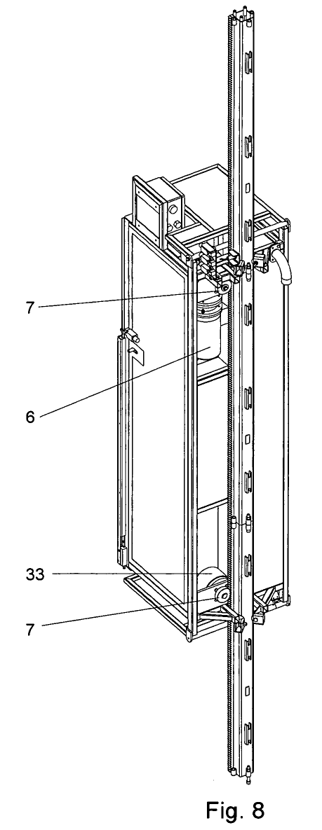

FIG. 8 shows a perspective view of the elevator where it is possible to see the assembly of the version of the elevator with a parachute brake.

### DESCRIPTION OF THE PREFERRED WAY TO ASSEMBLE THE SYSTEM

FIG. 1 shows that the load-bearing member (1) is fixed to the mobile element (2), it is made up of many modules (3), each one of them consisting of a section of the structural tube mast, with the rack (4) fixed to the end of one of their sides, screwed by the adjoining ends and anchored to the construction with bracing that adapts to the type of application of the elevator.

The load-bearing member (1) enables operators to build the elevator in sections—operators can assemble sections of the mast, one on top of another, and at the same time they can join the fixing devices to the masts in order to anchor the modules to the construction. Logically, to disassemble the elevator the order of this procedure has to be reversed.

The mobile element (2) is a cabin with a frame with the rolling and guiding elements (5) of the elevator, the pinions (7), the drive groups (6), the parachute brake (33) and the button panel (8). The button panel can be seen in FIG. 2. They are all integrated in a parallelepiped that is enclosed all around. The cabin has access doors, windows (9), a trapdoor on the floor (10) and a hatch on the ceiling (11) to get out of the cabin. There are also lower (10) and upper (11) safety trays to detect any possible obstacle that may be in the way of the elevator.

As you can see from FIG. 2, the cabin and the frame form one continuous piece in this lift which is made up of square tubes and masts folded to form a “b” (13) that are welded together to make a parallelepiped. The masts folded in “b” (13) are parallel in the front part of the cabin and act as a guide for the sliding guillotine doors that make the access to the lift. These tubes are connected together by means of a lower cross beam (15), making a rectangular frame in the vertical plane. At an intermediate height there is a square tube (16) that divides this area into two unequal sections, with the lower one being used to access and exit the cabin as it is larger than the upper one which will be used as a window. The parallel plane created by the aforementioned parts is made up of square tubes welded together. The four vertexes belonging to the two structures created by the described walls are joined together using horizontal square tubes (17), which close off the parallelepiped shape.

The back wall is composed of 3 square vertical tubes (18) joined together by welding them to an upper (19) and lower (20) cross beam creating a rectangular shape in the vertical plane. Both the upper and lower cross beams are square tubes. The central vertical tube (18) divides the rectangle in two areas of approximately the same size. Looking from the access towards the mast, in part of the left area there is a series of horizontal round tubes (21) welded onto the two longitudinal beams at intervals of equal distance, creating a vertical stairs inside the cabin. The join between the horizontal tube and the longitudinal beams is done using plate-like bars, whose function it is to separate the rungs between the cabin wall. In the lower part of the same area there is an eyebolt welded between two square tubes that join the central vertical and left vertical tubes. A little higher than half way above the left area there is a horizontal square tube that joins the two longitudinal beams with the function of strengthening the structure.

The following describes the area that appears to the right. There are two square tubes welded to the two longitudinal beams, which divide the right area into three parts. The upper and lower parts have the same dimensions and a larger surface area than the central part. Both parts have a plate joined to the cross beam, the longitudinal beam and the dividing tube to which the motorised groups (6) and the parachute brakes (33), if it has them, are attached by screws from inside the cabin. They are placed in opposite directions to each other and reach the differential bridle in the circular opening in the aforementioned plates where the axis goes to the exterior.

With the layout commented on, the risk of the pinion and rack disengaging is also eliminated thanks to the inverse positioning of the gear motor (6) with the release levers close to each other which assists their movement. The attack levers (7) are also as far away as possible from each other, close to the rolling guides (5) to guarantee the full engagement of the pinion with the rack independent of the irregularities of the carrying part. This situation is also reinforced by the fact the pinions (7) are wider than the rack (4). This is also carried out in the parachute brake assembly (33).

Each motorised group is protected by a metal cover (23), which also protects anyone in the cabin from accidentally being trapped in moving parts and facilitates access to the motorised groups (6) and/or the parachute brakes (33) from the inside of the cabin. The push-button panel (8) rests on a “U” shaped support (24), placed in a vertical position. This is joined to the horizontal angular cross bar on the lower part and a horizontal bar on the upper part, with both being joined to the longitudinal beams. The rest of the back wall area is protected against accidents using a screwed on covering.

The left wall of the parallelepiped-shaped cabin, as seen from the cabin, is divided by two horizontal square tubes into three unequal areas. These two tubes are welded very close to each other and serve to hold an eyebolt (25) welded between them on the outside of the cabin. Of the remaining two areas, the lower one is larger (in length) than the upper one. The latter is destined to provide a window (9) while the lower and central ones are closed by means of the screwed on covering.

The right wall of the parallelepiped-shaped cabin, seen from the list access, is closed by means of the screwed-on covering (26) in which an oval hole has been previously made situated to one side of the rectangle close to the access door and a little higher than the centre of this rectangle. The access door's release lever (27) passes through this oval hole. In the upper part of the wall, sticking out from it, there is a support made from three square tubes joined to form a rectangle (28) with the upper horizontal crossbeam which serves to secure the lift's electric housing unit (29), which is screwed to two bars welded to the support.

The modular carrying unit (1) extends vertically along the construction held by the cabin's longitudinal beams on the mast in the space between the roller guides (5) and the attack pinions (7). The four rolling guides (5.1) are mounted projecting onto the four square tubes welded perpendicular to the flat back wall of the cabin—more specifically there are two in the upper cross beam and two in the lower cross beam, with these tubes being strengthened by means of square tubes that join the projecting ends to the cross beams. In one of the upper strengtheners a support is placed in which the ends of the lift run (30) are mounted. By means of supports welded to the aforementioned tubes, these rollers are placed at an angle of approximately 45° with respect to the back wall of the cabin, in such a way they guide using the mast's rear corners. A support is welded to the cross beam's inductive detector (31) on the support of one of the upper rollers. On the front part of the cross beam three rollers are used as guides, one on the upper part and two on the lower part. On the upper part, the roller support (5.2) is welded to the cabin's horizontal longitudinal beam and is positioned at 45° with respect to the back wall of the cabin, in order to guide using the corner of the opposite mast where the rack is welded (4). In the upper part, there is a guiding roller support (5.3) welded to the same plane as described in the upper part to guide through the corner of the mast. The other guiding roller (5.4) is welded to the longitudinal beam at a perpendicular angle to the back wall, in such a way it guides using the flat face of the mast, in a position close to the corner where the rack is welded.

As will be understood, when building a modular lift such as the one that has just been described above, it is a really beneficial solution to the current situation, above all from the point of view of construction, mounting and capacity of the adaptation that modularity brings, together with some increased security features as also clearly pointed out in the above description. It is not considered necessary to make the content of this description more detailed in order for an expert in the subject to be able to understand what is being stated and the advantages derived from the invention, in addition to developing and carrying it out in practice.

However, it must be understood that the invention has been described according to how it should preferably be built, although some modifications could be made without this meaning any alteration to the basics. Such changes especially include the shape, the size and/or the materials the whole lift or its parts are manufactured from.

1. The modular lift with a motorised cabin on a mast of the type that incorporates traction through the pinion-rack with the mast made from a structural tube as a carrying part (1) and a cabin (2) provided by a frame with the rolling and guiding parts of the lift (5), pinions (7), the tractor groups (6) and the control button panel (8) integrated into it, is characterised because all this together is integrated into a parallelepiped shape closed on all sides in which it has been planned that the motorised groups (6) are placed in inverted positions to each other with the effect of eliminating the risk of pinion (7) and rack (4) disengaging. This also facilitates access to the respective release levers as they are close to each other, assisting how they work with the attack pinions (7) that are as far away as possible from each other but close to the rolling guides (5), guaranteeing the complete engagement of the pinion with the rack independent of the irregularities of the carrying part. Also, the pinions are wider than the rack (4) and each motorised group is protected by a metal cover (23) which also provides protection for the people in the cabin at the same time from being accidentally trapped in the moving parts. In addition, this facilitates access to the motors (6) from inside the cabin with the covers (23) having oval holes cut in them where the release levers for the motor brakes come though.

2. Modular lift with a motorised cabin on a mast, as described in claim 1, characterised by integrating rolling and guiding (5) parts in the cabin, which are placed in such a way they hold the mast, thereby eliminating the aforementioned risk of the pinion and rack becoming disengaged, and with it being guided on two areas. One is connected to the upper part which has three rollers and one is connected to the lower part which has four rollers. This guarantees the optimum guidance without interfering with the cogs on the rack, and without this guide system interfering with the bracings that join the carrying part to the structure of the lift with one roller (5.4) taking care of any counteracting contact with the lower part of the cabin with the mast as a consequence of the weight of the cabin and its load in such a way that in case the axis breaks on any of the rollers (5), the supports (5.2, 5.3) act as guiding security parts guaranteeing the moving part (2) will never come out of the carrying area (1).

3. Modular lift with a motorised cabin on a mast, as described in claim 1, characterised because the moving part (2) adopts a configuration of a normally shaped parallelepiped closed on all sides which notably reduces the base of the moving part (2) and maintains the cabin dimensions at the same time as it allows access from the inside to the tractor groups (6), the attack pinions (7) and the button control panel (8), with the inside of the cabin being accessed though a guillotine access door (32). This design makes maximum use of the space allowed and reduces the space required for the access to a minimum. The height of the door is generally lower than that for the future users to provide them with an additional protection from possible accidents.

4. Modular lift with a motorised cabin on a mast, as described in claim 1, characterised because the modular carrying part (4) is lodged in the existing space between the guiding rollers (5) and the attack pinions (7) at the end of one of its lateral faces with the teeth pointing outwards. The respective axes are situated on planes that have a predetermined inclination with respect to the cabin wall plane and the fact that the carrying part (1) is constructed from a structural tube of reduced dimensions that means the need for a minimal area for installing the list is achieved in a compact way. Thus the pinions (7) are better protected by the support structure of the rolling guides (5), which allows the vertical positioning of the rack (4) and attack pinions (7) on the gear motors (6) in the cabin (2).

5. Modular lift with a motorised cabin on a mast, as described in claim 1, also characterised because the vertical position of the gear motors (6) means both can be positioned inversely with the release levers adjoining and close to each other to facilitate the action of them, with the attack pinions (7) being as far apart from each other as possible, yet close to the guiding rollers (5). This guarantees complete engagement of the pinion (7) with the rack (4), regardless of the irregularities of the carrying part (1) layout with this situation being reinforced by the fact the pinions (7) are wider than the rack (4).

6. Modular lift with a motorised cabin on a mast, as described in claim 1, in which one of the motorised groups (6) to be substituted by a parachute brake (33).
